(19) United States
(12) Patent Application Publication
(10) Pub. No.: US 2015/0011122 A1
(43) Pub. Date: Jan. 8, 2015

(54) SOCKET CONNECTOR WITH SHIELDING STRUCTURE

(71) Applicant: HON HAI PRECISION INDUSTRY CO., LTD., New Taipei (TW)

(72) Inventors: YEN-CHIH CHANG, New Taipei (TW); TZU-YAO HWANG, New Taipei (TW)

(21) Appl. No.: 14/323,252

(22) Filed: Jul. 3, 2014

(30) Foreign Application Priority Data
Jul. 3, 2013 (TW) 102212480

(51) Int. Cl. H01R 13/6588

(52) U.S. Cl. CPC H01R 13/6588
USPC 439/607.09

(57) ABSTRACT

A socket connector includes an insulative base (2), a plurality of contacts (3) therein with an engaging portion (32) and a floating cover (5). The floating cover (5) includes a plurality of through holes (53) for receiving the engaging portions (32) extending therethrough. The socket connector includes a metallic shell (4) having a plurality of receiving holes (41) for receiving the contacts therein and electrically engaging with a metallic surface (52) formed on bottom of the floating cover (5).

### BACKGROUND OF THE INVENTION

1. Field of the Invention

The present invention relates to a socket connector, and more particularly to a socket connector with shielding structure.

2. Description of the Related Art

A conventional socket connector attaching a CPU to a PCB has a corresponding structure to mate with the conductive pads of the CPU to shorten telecommunication transporting path for obtaining lower resistance. By this way, it can prevent signal disturbance in high speed transporting circumstance. Such a typical socket connector generally includes a base mounted on a PCB, and a plurality of contacts residing in the base. A pressing force is needed to make the CPU press the contacts for making the contacts be elastically deformed, which enables the contacting portions of the contacts to mate readily with conductive pads of the CPU.

U.S. Pat. No. 7,322,830 issued to Szu on Jan. 29, 2008, discloses such a typical socket connector. The socket connector includes a base mounted on a PCB, a cover for holding a CPU, and a plurality of contacts each of which has a supporting portion received in the base and an engaging portion reaching out of the base. The cover is formed with a number of through holes for fixing the contact. Every engaging portion crosses and partially extends out of the corresponding through hole. In process of assembly, each contact is pressed and generates elastic deformation, which causes its engaging portion to move and scrape a surface of the corresponding conductive pad due to the pressure from the CPU. Because the CPU and the cover can move with the engaging portions simultaneously, the engaging portions keep motionless relative to the corresponding conductive pads of the CPU.

However, the contacts are easily interference with each other because an absence of shielding to thereof for preventing from crosstalk.

Therefore, an improved socket connector are desired to overcome the disadvantages of the related arts.

### SUMMARY OF THE INVENTION

An object of the present invention is to provide a socket connector with shielding structure for preventing from crosstalk.

In order to achieve the above-mentioned object, a socket connector in accordance with a preferred embodiment of the present invention includes an insulative base, a plurality of contacts therein with an engaging portions and a floating cover. The floating cover includes a plurality of through holes for receiving the engaging portions extending therethrough. The socket connector includes a metallic shell having a plurality of receiving holes for receiving the contacts therein and electrically engaging with a metallic surface formed on bottom of the floating cover for preventing from crosstalk.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a socket connector in accordance with the preferred embodiment of the present invention;

FIG. 2 is an exploded perspective view of the socket connector shown in FIG. 1;

FIG. 3 is a bottom perspective view of a metallic shell of the socket connector shown in FIG. 2;

FIG. 4 is a cross-section view of the socket connector taken along line 4-4 of FIG. 1; and

FIG. 5 is a cross-section view of the socket connector shown in FIG. 4 in which the shielding cover moved to another status.

### DETAILED DESCRIPTION OF THE INVENTION

Reference will now be made to the drawing figures to describe the preferred embodiments of the present invention in detail.

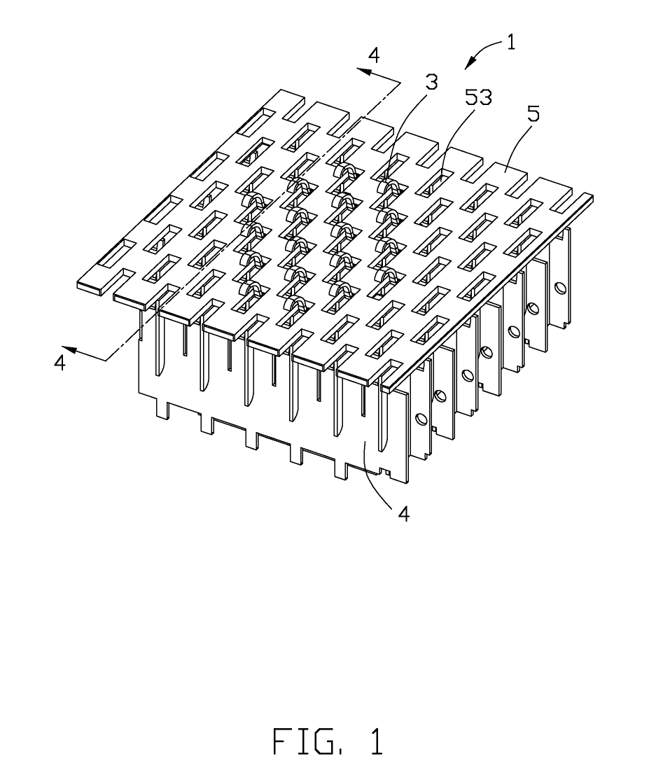

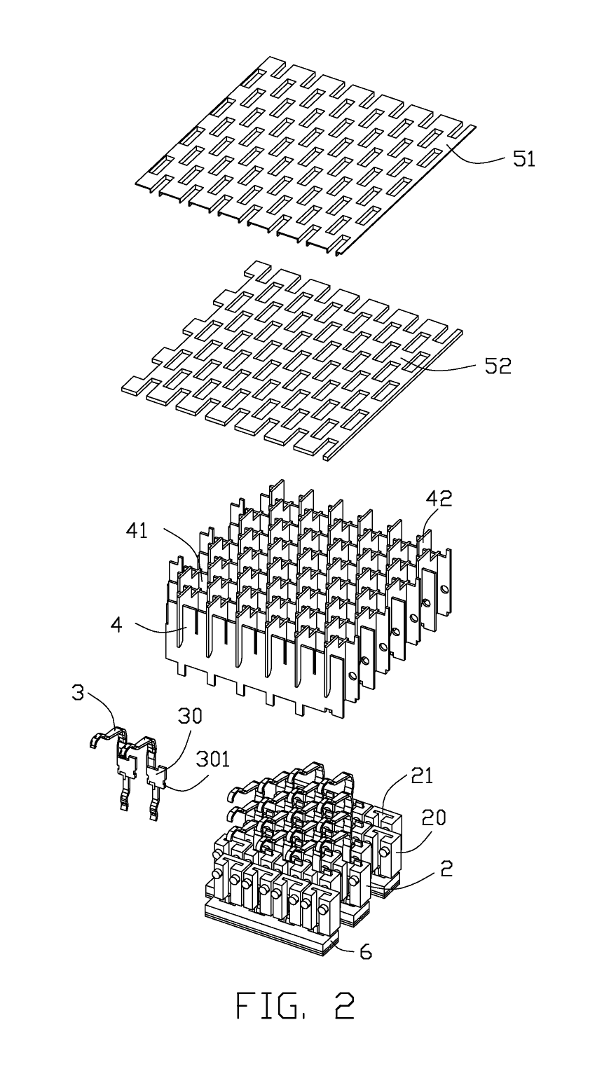

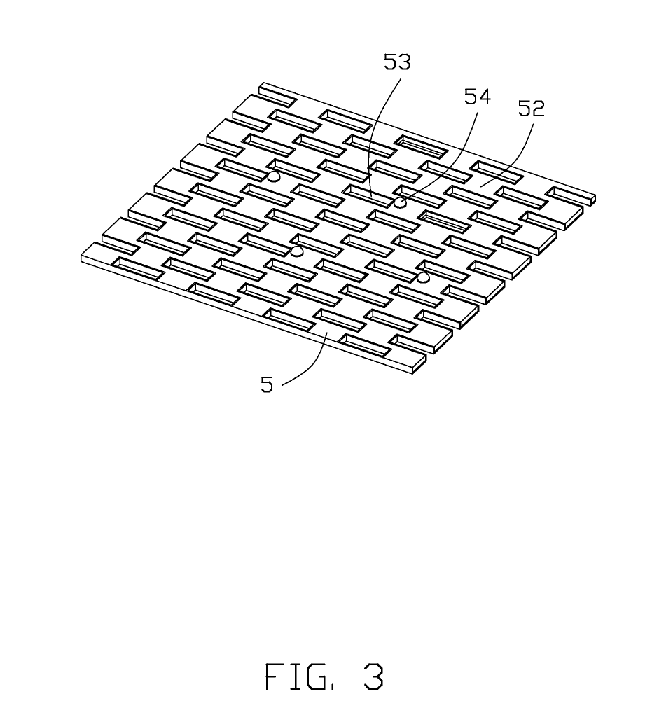

As illustrated in FIGS. 1 to 3, a socket connector 1 for attaching a CPU (not shown) to a PCB (not shown) includes an insulative base 2 mounted on the PCB, a plurality of contacts 3 residing in the insulative base 2, a metallic shell 4 retained in the insulative base 2, a floating horizontal cover 5 mounting on the insulative base 2 and moveable in a vertical direction for holding the CPU and a plurality of contacts 3 residing in the base 2 and a horizontal bottom cover plate 6 located below the metallic shell 4.

The insulative base 2 is divided to a plurality of base uints 20 extending along a first direction and being hold by the metallic shell 4 together. The contact 3 are associated in the base uints 20 thereby forming a plurality of terminal modules. The insulative base 2 is facing the cover 5 and defines a plurality of passageways 21 receiving the contacts 3. The metallic shell 4 is attached to the insulative base 2. The metallic shell 4 includes a plurality of receiving holes 41 for receiving the contacts 3 therein, i.e. the metallic shell 4 defining a grid like cross-sectional configuration in a top view, and a plurality of protruding portions 42 for supporting the floating cover 5 on the metallic shell 4.

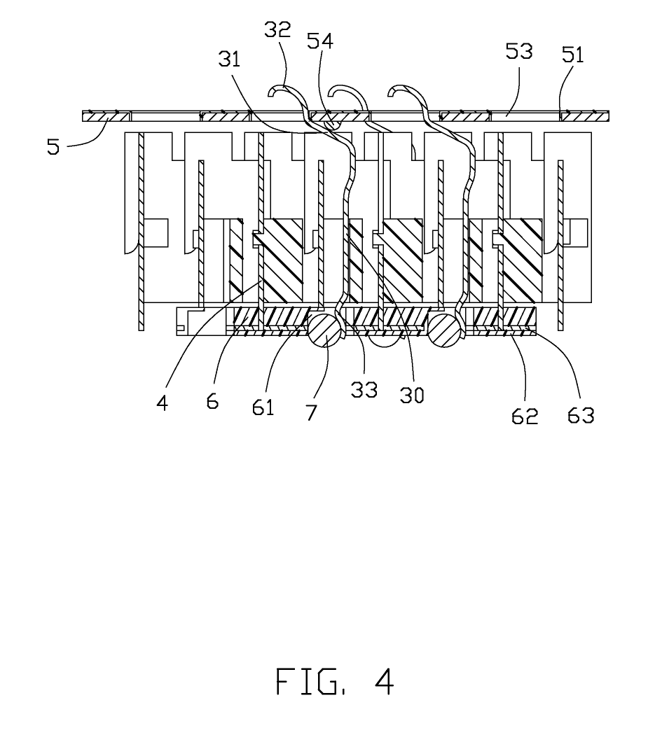

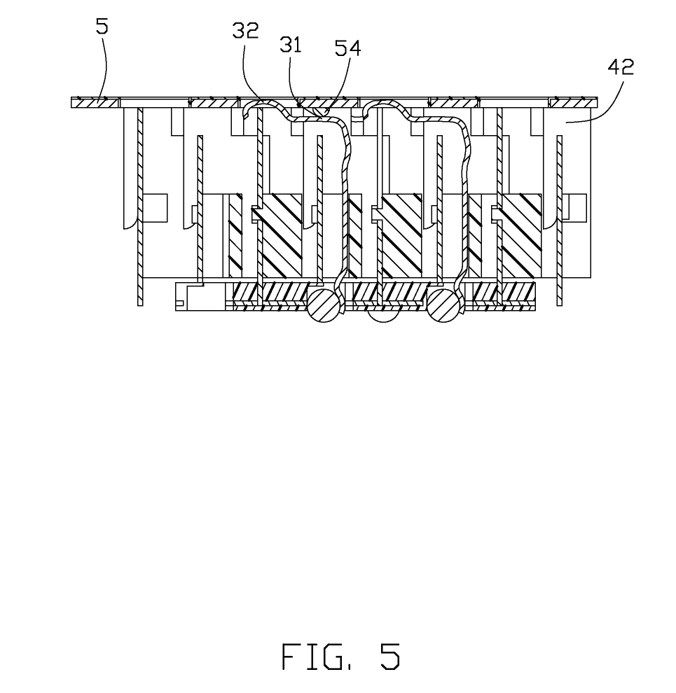

Referring to FIG. 4 and FIG. 5, the contact 3 comprises a supporting portion 30 defining barbs 301 retained in the insulative base 2, a spring portion 31 extending upwards and bended from the supporting portion 30, an engaging portion 32 extending upwards from the extending portion 31 in a second direction, in said top view, angled with the first direction for contacting with the CPU and a soldering portion 33 which is planar and extends from the bottom of the supporting portion 30 for soldering to the PCB.

The floating horizontal cover 5 is movably mounted above the insulative base 2 and is supported by the protruding portion 42 of the metallic shell 4. The floating cover 5 is configuration of a rectangular shape like the insulative base 2 and comprises an upper insulative surface 51 and a metallic surface 52 located on bottom side of the insulative surface 51. The floating cover 5 forms a plurality of through holes 53 for receiving the engaging portions 32 of the contacts 3 extending therethrough to contacting with the CPU. The insulative surface 51 is provided by an insulative plate or an insulative coating layer which prevents the metallic surface 52 from shorting with the CPU and extends into the through holes 53. The metallic surface 52 is provided by a metallic plate or a metallic coating layer for electrically connecting with the metallic shell 4. The floating cover 5 defines a metallic grounding portion 54 being formed on bottom side of the metallic surface 52 and always engaging with at least one of the contact 3, thereby building a grounding path between the metallic surface 52 and the grounding contact 3 for preventing crosstalk. The metallic grounding portion 54 is formed by a solder ball adhering to the metallic surface 52.

In assembly of the CPU and the socket connector 1, the CPU and the cover 5 moves downwards while moves along an extending direction of the spring portion 31. The floating cover 5 is moved between a first position in which the cover 5 disengages with the metallic shell 4 and the contacts 3 protrudes out of the cover 5 and do not pressed downwardly by the CPU and a second position in which the CPU presses downwardly the contact 3 and the spring portion 31 of the contact 3 deforms so that the engaging portion 32 moves approximately along a track of curve, until the cover 5 engages with the protruding portion 42 of the metallic shell 4 for providing another grounding path and preventing from crosstalk.

The horizontal bottom cover plate 6 defines a plurality of recesses 61 to receive corresponding solder balls 7 which are soldered to the lower soldering portion 33 of the corresponding contacts 3, respectively, and said horizontal bottom cover plate 6 includes an insular plate 62 and an embedded metallic shield layer 63 mechanically and electrically connecting the metallic shell 4, thereby the metallic shell 4 electrically connects with the upper cover 5 and bottom cover plate 6 for grounding.

It is to be understood, however, that even though numerous characteristics and advantages of the present invention have been set forth in the foregoing description, together with details of the structure and function of the invention, the dislosure is illustrative only, and changes may be made in detail, especially in matters of shape, size, and arrangement of parts within the principles of the invention to the full extent indicated by the board general meaning of the terms in which the appended claims are expressed.

What is claimed is:

1. A socket connector comprising:
an insulative base comprising a plurality of passageways receiving a plurality of contacts therein with an engaging portions;
a floating cover movably mounted above the insulative base and comprising a plurality of through holes for receiving the engaging portions of the contacts extending therethrough; and
wherein the socket connector comprises a metallic shell retained in the insulative base, the metallic shell comprises a plurality of receiving holes to receive the contacts therein and electrically engages with a metallic surface formed on bottom of the floating cover.

2. The socket connector as described in claim 1, wherein the metallic shell comprises a plurality of protruding portions engaging with the metallic surface.

3. The socket connector as described in claim 1, wherein the floating cover comprises an upper insulative surface which prevents the metallic surface from short circuit and extends into the through holes.

4. The socket connector as described in claim 1, wherein the floating cover comprises a metallic grounding portion being formed on bottom side of the metallic surface and always engaging with at least one of the contact, thereby building another grounding path between the metallic surface and the grounding contact for preventing crosstalk.

5. The socket connector as described in claim 4, wherein the metallic grounding portion is formed by a solder ball adhering to the metallic surface.

6. The socket connector as described in claim 3, wherein the floating cover is moved between a first position in which the cover disengages with the metallic shell and the contacts protrudes out of the cover and a second position in which the contact are pressed downwardly and deformed so that the engaging portion moves approximately along a track of curve, until the cover engages with the metallic shell.

7. A socket connector comprising:
an insulative base comprising a plurality of passageways receiving a plurality of contacts therein with an engaging portions for electrically connecting with a CPU; and
a cover movably mounted above the insulative base and comprising a plurality of through holes for receiving the engaging portions of the contacts extending therethrough;
wherein the cover comprises an upper insulative surface and a metallic surface located on bottom side of the insulative surface and electrically engaging with the selected contacts.

8. The socket connector as described in claim 7, wherein said cover is up and down floatable.

9. The socket connector as described in claim 7, wherein the cover comprises a metallic grounding portion being formed on bottom side of the metallic surface and always engaging with at least one of the contact, thereby building a grounding path between the metallic surface and the least one grounding contacts for preventing crosstalk.

10. The socket connector as described in claim 9, wherein the metallic grounding portion is formed by a solder ball adhering to the metallic surface.

11. The socket connector as described in claim 7, wherein the upper insulative surface prevents the metallic surface from short circuit and extends into the through holes.

12. The socket connector as described in claim 7, wherein the insulative surface is provided by an insulative plate or an insulative coating layer.

13. The socket connector as described in claim 7, wherein the metallic surface is provided by a metallic plate or a metallic coating layer for electrically connecting with the metallic shell.

14. A socket connector for use with an electronic package, comprising:
a metallic shield structure defining a grid like cross-sectional configuration in a top view;
a terminal module assembly secured to the shield structure and including a plurality of contacts associated therewith, each of said contacts including an upper mating section and a lower mounting section in a vertical direction, said contacts being categorized with grounding contacts and signal contacts;
a horizontal upper cover plate mounted above the shield structure and defining a plurality of through holes through which the upper mating sections of the contacts extend upwardly; wherein
the upper cover plate includes an insulative structure on an upper side thereof for not improperly electrically connecting to the electronic package which is adapted to be mounted upon the cover plate, and a metallic structure on a bottom side thereof for mechanically and electrically connecting the shield structure.

15. The socket connector as claimed in claim 14, wherein said metallic structure further mechanically and electrically connects to the corresponding grounding contacts.

16. The socket connector as claimed in claim 15, wherein said terminal module assembly includes a plurality of terminal modules each defining an insulator extending along a first direction, in said top view, with the associated contacts therein.

17. The socket connector as claimed in claim 16, wherein the upper mating section extends in a second direction, in said top view, angled with said first direction.

18. The socket connector as claimed in claim 15, wherein said cover plate is moveable in said vertical direction.

19. The socket connector as claimed in claim 15, wherein each of said through hole is coated with insulative material on interior surfaces.

20. The socket connector as claimed in claim 15, further including a horizontal bottom cover plate located below the shield structure, wherein said horizontal bottom cover plate defines a plurality of recesses to receive corresponding solder balls which are soldered to the lower mounting sections of the corresponding contacts, respectively, and said horizontal bottom cover plate includes an embedded metallic shield layer mechanically and electrically connecting the shield structure.
